(19) United States
(12) Patent Application Publication
(10) Pub. No.: US 2003/0034048 A1
(43) Pub. Date: Feb. 20, 2003

(54) Back-surface cleaning method for cleaning the back surface of a silicon wafer

(75) Inventors: Yoshiya Hagimoto, Tokyo (JP); Yasushi Sasaki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/195,064

(22) Filed: Jul. 15, 2002

(30) Foreign Application Priority Data
Aug. 17, 2001 (JP) 2001-247775

(51) Int. Cl. B08B 3/02

(52) U.S. Cl. 134/3; 134/902; 134/28; 134/30; 134/95.2; 134/95.3; 134/153; 134/102.1; 134/56 R

(57) ABSTRACT

A back-surface cleaning system first removes contaminants such as copper that adhere to the back surface of a silicon wafer by means of a first cleaning with an acidic solution and then removes compounds that would be produced on the back surface of the silicon wafer while cleaning with the acidic solution by cleaning with pure water into which ozone has been mixed, whereby the back surface of a silicon wafer having integrated circuits formed of copper on its front surface can be effectively cleaned.

### BACKGROUND OF THE INVENTION

1. Field of the Invention

The present invention relates to a back-surface cleaning method for cleaning the back surface of a silicon wafer, and more particularly to a back-surface cleaning method for cleaning the back surface of a disk-shaped silicon wafer having at least a portion of integrated circuits formed of copper on its front surface.

2. Description of the Related Art

The development of integrated circuit devices with higher performance is progressing, and the fabrication of each part of the integrated circuits from copper is being investigated. When integrated circuits are formed of copper on the surface of a silicon wafer, however, contaminants such as copper adhere to the back surface of the silicon wafer, thereby necessitating the cleaning of the back surface of the silicon wafer.

Referring now to FIG. 1, one example of a back-surface cleaning method of the prior art for removing contaminants such as copper from the back surface of a silicon wafer is next described. A silicon wafer having integrated circuits on its front surface-that are formed of copper is first conveyed to a back-surface cleaning system and secured in a chuck (Step S1), and the secured silicon wafer is then rotated at low speed within a horizontal plane (Step S2).

The back surface of this slowly rotating silicon wafer is next cleaned by an acidic solution of FPM (a hydrogen fluoride—hydrogen peroxide solution), which is sprayed from below (Step S3), and when this cleaning operation has been executed for a prescribed period of time, the FPM spray is halted (Steps S3-S5).

The back surface of the silicon wafer that has been cleaned by FPM is next cleaned by spraying with pure water from below (Step S6). When this cleaning has been executed for a prescribed period of time, the pure water spray is halted (Steps S6-S8).

The silicon wafer that has been cleaned by pure water is then rotated at high speed (Step S9), and when this high-speed rotation has been carried out for a prescribed time period, the rotation of the silicon wafer is stopped (Steps S9-S11). The silicon wafer is thus dried, and the dried silicon wafer is finally taken out to complete the operation (Step S12).

As described above, cleaning the back surface of a silicon wafer with the acidic solution FPM enables effective removal of contaminants such as copper. In place of the above-described FPM, the cleaning of these contaminants may employ DHF (Dilute Hydrogen Fluoride Solution), sulfuric acid, nitric acid, or a mixture of at least one of these with pure water.

Although cleaning the back surface of a silicon wafer with an acidic solution of FPM as described in the foregoing explanation enables effective removal of contaminants such as copper, compounds are produced on the back surface of the silicon wafer when cleaning with this acidic solution. Although the back surface of the silicon wafer is cleaned with pure water in the back-surface cleaning method of the prior art, it is difficult to effectively remove these compounds by cleaning with pure water.

### SUMMARY OF THE INVENTION

It is an object of the present invention to provide a back-surface cleaning method that can effectively eliminate contaminants such as copper that adhere to the back surface of a silicon wafer by using an acidic solution, and that can also effectively eliminate compounds that are produced on the back surface of the silicon wafer when cleaning with this acidic solution.

The first back-surface cleaning system of the present invention includes: acidic cleaning means, ozone cleaning means, water cleaning means, and back-surface drying means. The first back-surface cleaning system of the present invention cleans the back surface of a disk-shaped silicon wafer having at least a portion of integrated circuits formed of copper on its front surface. In this case, the acidic cleaning means is first used to clean the back surface of the silicon wafer with an acidic solution, and the back surface of the silicon wafer that has been cleaned by this acidic solution is then cleaned by the ozone cleaning means with pure water into which ozone has been mixed. The back surface of the silicon wafer, which has been cleaned by this pure water that has been mixed with ozone, is then cleaned by a water cleaning means using pure water that has not been mixed with ozone, and the back surface of the silicon wafer that has been cleaned by this pure water is then dried by the back-surface drying means.

The second back-surface cleaning system of the present invention includes: a wafer-securing element, a solution supply element, a water supply element, an ozone-mixing element, an acidic cleaning means, an ozone cleaning means, a water cleaning means, and a back-surface drying means. A disk-shaped silicon wafer having at least a portion of integrated circuits formed of copper on its front surface is secured by the wafer-securing element. The solution supply element supplies an acidic solution to the back surface of the secured silicon wafer, the water supply element supplies pure water to the back surface of the secured silicon wafer, and the ozone-mixing element mixes ozone in this pure water. When cleaning the back surface of the silicon wafer, the acidic cleaning means cleans the back surface of the silicon wafer that is secured by the wafer-securing element with the acidic solution of the solution supply element, and the ozone cleaning means cleans the back surface of the cleaned silicon wafer with pure water from the water supply element into which ozone has been mixed by the ozone-mixing element. The water cleaning means cleans the back surface of the cleaned silicon wafer with the pure water from the water supply element, and the back-surface drying means dries the back surface of the cleaned silicon wafer.

Thus, in the back-surface cleaning method that is realized by the back-surface cleaning system of the present invention, contaminants such as copper adhere to the back surface of a silicon wafer that has at least a portion of integrated circuits on its front surface formed of copper, but these contaminants are removed by initial cleaning that uses the acidic solution. Although compounds are produced on the back surface of the silicon wafer when cleaning with this acidic solution, these compounds are removed by cleaning with pure water into which ozone has been mixed. Finally, the back surface of the silicon wafer is cleaned with pure water and dried, whereby the back surface of the silicon wafer is clean.

As another mode of the present invention, the ozone-mixing element electrolyzes the pure water that is supplied from the water supply element to produce ozone, thereby enabling pure water that is mixed with ozone to be generated from pure water, and, because ozone need not be prepared separately from the pure water, enabling a reduction in the running costs of cleaning the back surface.

Each of the various means described in the present invention may be formed to realize respective functions, and these forms may include, for example, dedicated hardware for realizing a prescribed function, an operation control apparatus that is provided with a prescribed function by means of a computer program, prescribed functions that are realized within a operation control apparatus by means of a computer program, or a combination of these forms.

Further, each of the various means described in the present invention need not exist independently, and a particular means may exist as a part of another means. In addition, each of the various elements described in the present invention may be hardware that is formed to realize a function, but a particular element may also be formed as a portion of another element.

The operation control apparatus described in the present invention may be hardware that can read data of a computer program and execute the corresponding processing operation, and for example, may be hardware in which a CPU (Central Processing Unit) is the main unit to which various devices such as ROM (Read Only Memory), RAM (Random Access Memory), and I/F (Interface) unit are connected.

In the present invention, causing an operation control apparatus to execute each of various operations in accordance with a computer program allows for the operation of various devices under the control of the operation control apparatus. For example, saving various data in the operation control apparatus may include storing various data in an information storage medium such as RAM that is included as a part of the operation control apparatus and storing various data in an information storage medium such as a FD (Floppy Disc) that can be loaded in the operation control apparatus so as to allow easy exchange.

The disk-shaped form that is described in the present invention need only be a form that can be generally recognized as a disk and need not be a form in which the planar shape is a perfect circle, and, for example, may include forms in which V-shaped notches or a straight orientation flat is formed in the outer circumference of a circle.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a flow chart showing the back-surface cleaning method of an example of the prior art;

FIG. 2 is a flow chart showing the back-surface cleaning method realized by the back-surface cleaning system of an embodiment of the present invention;

FIG. 3 is a schematic view showing the overall construction of a back-surface cleaning system;

FIG. 4 is a block diagram showing the physical element of an operation control apparatus; and

FIG. 5 is a graph for comparing the actual results of cleaning the back surface of a silicon wafer using both the back-surface cleaning system of the present invention and a back-surface cleaning system of the prior art.

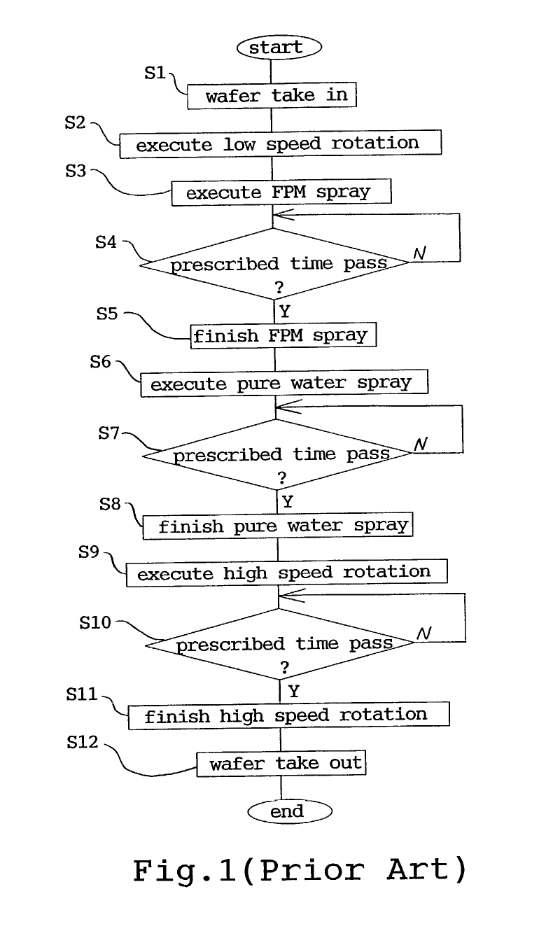

### DETAILED DESCRIPTION OF THE PREFERRED EMBODIMENTS

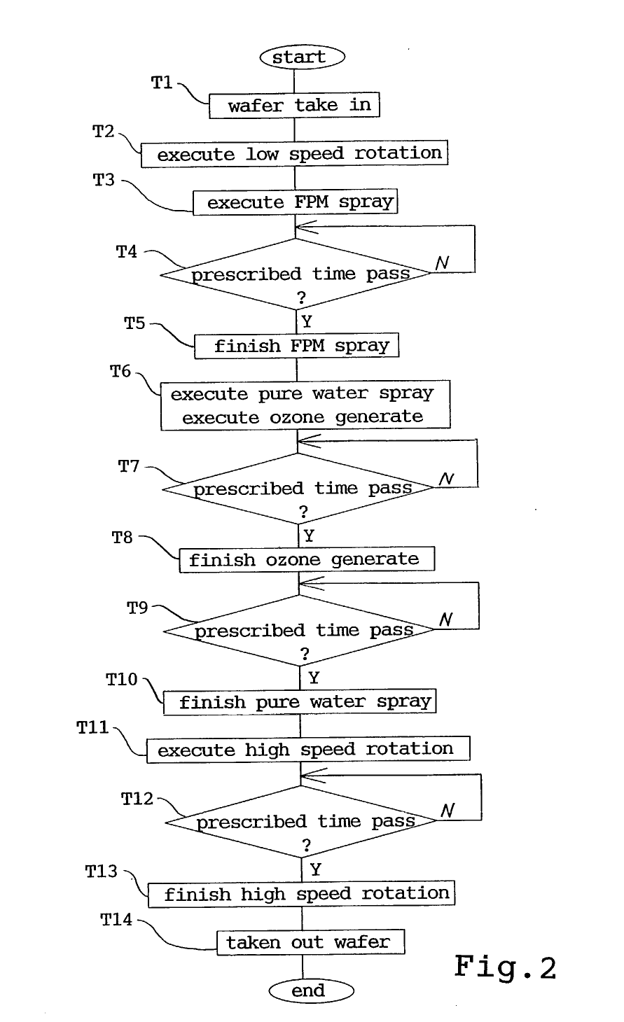

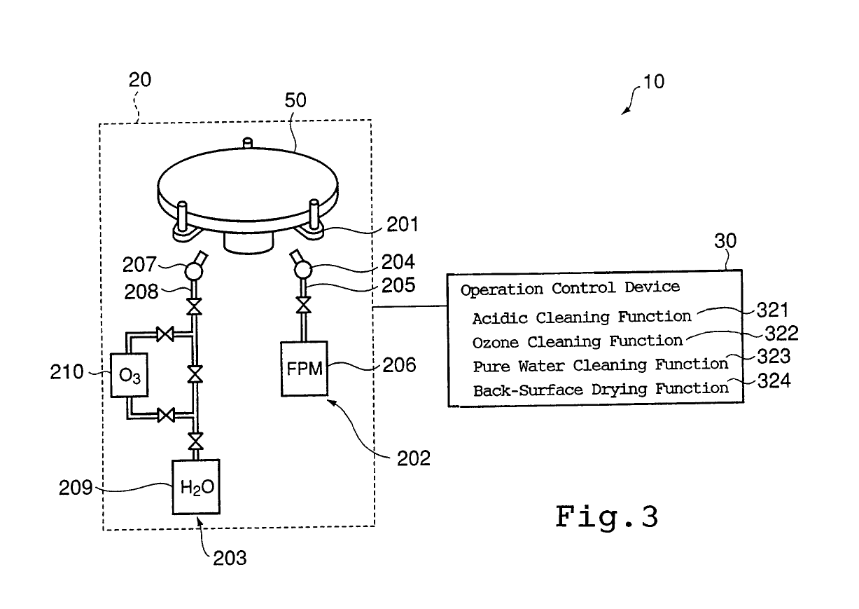

Referring now to FIGS. 2 to 5, an embodiment of the present invention is next described. As shown in FIG. 3, back-surface cleaning system 10 of this embodiment includes cleaning main unit 20 and operation control apparatus 30, this cleaning main unit 20 and operation control apparatus 30 being connected by network 40.

Cleaning main unit 20 includes wafer-securing element 201, and this wafer-securing element 201 both secures silicon wafer 50 such that the back surface is the lower surface and rotates silicon wafer 50 within a horizontal plane. Solution supply element 202 for supplying an acidic solution to the back surface of silicon wafer 50 that is thus secured and water supply element 203 for supplying pure water to the back surface of silicon wafer 50 are arranged below silicon wafer 50.

More specifically, solution supply element 202 includes spray nozzle 204 that is directed toward the back surface of silicon wafer 50 from below, and solution tank 206 is linked to this spray nozzle 204 by way of piping 205. This solution tank 206 stores the acidic solution FPM, and this FPM is pumped to piping 205 by an incorporated pump element (not shown in the figure).

Similarly, water supply element 203 also includes spray nozzle 207 that is directed toward the back surface of silicon wafer 50 from below, and pure water tank 209 is linked to this spray nozzle by way of piping 208. Pure water that is stored in this pure water tank 209 is also pumped to piping 208 by an incorporated pump element (not shown in the figure), but a branched route is formed midway in this piping 208.

Ozone-mixing element 210 is linked to this branched route in piping 208, and this ozone-mixing element 210 generates ozone by electrolyzing the pure water that is supplied from piping 208 of water supply element 203 and then mixes this ozone with the pure water that is sent by piping 208.

In back-surface cleaning system 10 of this embodiment, the FPM that is stored in solution tank 206 is produced at the proportions of, for example, HF: H₂02 : H₂O=1:1:20, and maintained at a constant temperature of, for example, 23° C. In addition, the water supply element 203 supplies pure water at a rate of flow of 2.0 L/min, and ozone-mixing element 210 generates ozone to realize a concentration of 8.0 ppm in pure water.

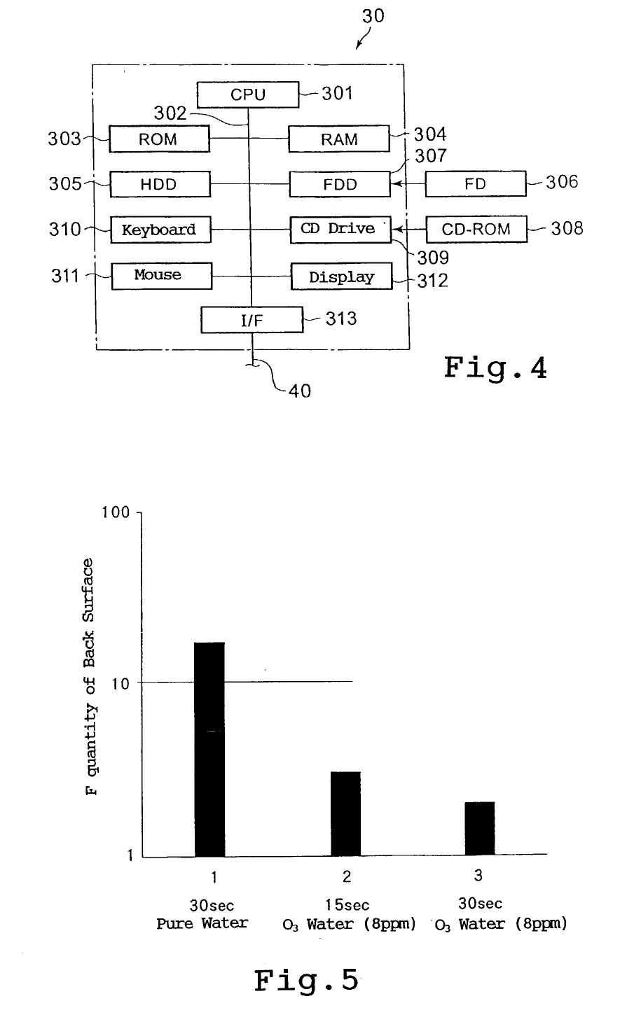

As shown in FIG. 4, operation control apparatus 30 includes CPU 301 as hardware that serves as the main unit of a computer, and this CPU 301 is connected by bus line 302 to hardware such as ROM 303, RAM 304, HDD (hard disk drive) 305, FDD (FD drive) 307 in which FD 306 is loaded in a freely exchangeable state, CD drive 309 in which CD (Compact Disk)-ROM 308 is loaded in a freely exchangeable state, keyboard 310, mouse 311, display 312, and I/F unit 313.

In operation control apparatus 30 of this embodiment, hardware such as ROM 303, RAM 304, HDD 305, exchangeable FD 306 and exchangeable CD-ROM 308 are suitable for information storage media, and various data or computer programs for CPU 301 are stored as software on at least one of these components.

As an example, a computer program for causing CPU 301 to execute various processes is stored beforehand on FD 306 or CD-ROM 308. This software is installed in advance on HDD 305, and, when operation control apparatus 30 is activated, is copied to RAM 304 and read to CPU 301.

The reading of an appropriate computer program and the corresponding control of the operations of each part of the cleaning main unit 20 by CPU 301 realizes the capability of operation control apparatus 30 to function as acidic cleaning function 321, ozone cleaning function 322, water cleaning function 323, and back-surface drying function 324 of this embodiment.

Acidic cleaning function 321 corresponds to the functions by which CPU 301, from I/F unit 313 and in accordance with a computer program that is stored in RAM 304, controls the operations of wafer-securing element 201 and solution supply element 202, whereby wafer-securing element 201 is caused to secure and rotate silicon wafer 50 at low speed, and in this state, solution supply element 202 is caused to operate to clean the back surface of silicon wafer 50 with FPM.

Ozone cleaning function 322 corresponds to the functions by which CPU 301, in accordance with the above-described computer program, controls the operations of wafer-securing element 201, pure water supplying element 203, and ozone-mixing element 210, whereby, upon completion of the above-described cleaning by FPM, water supply element 203 and ozone-mixing element 210 are caused to operate at the same time while the low-speed rotation of wafer-securing element 201 is continued without change to clean the back surface of silicon wafer 50 with pure water that has been mixed with ozone.

Water cleaning function 323 corresponds to the function by which CPU 301, in accordance with a computer program, controls the operations of wafer-securing element 201 and water supply element 203, whereby, upon completion of the above-described ozone cleaning, the operation of ozone-mixing element 210 is halted while the operation of wafer-securing element 201 and water supply element 203 is continued without change to clean the back surface of silicon wafer 50 with pure water.

Back-surface drying function 324 corresponds to the function by which CPU 301, in accordance with a computer program, controls the operation of wafer-securing element 201, whereby, upon completion of the above-described cleaning by pure water, the rotation of wafer-securing element 201 switches from low speed to high speed to dry the back surface of silicon wafer 50.

Each of the various means of operation control apparatus 30 as described above is realized through the use of components such as HDD 305 and I/F unit 313 as necessary, and is realized by the operation of hardware such as CPU 301 in accordance with a computer program that has been stored in information storage media such as RAM 304.

The computer program is stored in information storage media such as RAM 304 as software for causing hardware such as CPU 301 to sequentially execute processes such as: the process in which wafer-securing element 201 secures silicon wafer 50 and rotates silicon wafer 50 at low speed; the process in which, in this state, solution supply element 202 is caused to operate; the process in which water supply element 203 and ozone-mixing element 210 are brought into operation at the same time while the low-speed rotation of wafer-securing element 201 continues unchanged; the process in which ozone-mixing element 210 is halted while the operation of wafer-securing element 201 and water supply element is continued unchanged; and the process in which the rotation of wafer-securing element 201 is switched from low speed to high speed.

Explanation next regards the back-surface cleaning method that is realized using back-surface cleaning system 10 of the present embodiment in the above-described constitution. A plurality of silicon wafers 50 having at least a portion of integrated circuits on their front surfaces formed of copper are accommodated in a wafer cassette (not shown in the figure), and this wafer cassette is loaded in cleaning main unit 20 of back-surface cleaning system 10.

Operation control apparatus 30, which has detected this loading of the wafer cassette by means of the sensor output of cleaning main unit 20 then controls the operation of each component, whereby, for example, silicon wafer 50 is conveyed from the wafer cassette by a robot arm (not shown in the figure) to the interior of cleaning main unit 20 (Step T1).

Silicon wafer 50 that has been thus conveyed is secured by wafer-securing element 201 such that its back surface is directed downward and is then rotated by this wafer-securing element 201 in a horizontal plane at a low speed of approximately 500 rpm (Step T2). The back surfaces of silicon wafer 50 that is rotating at low speed is cleaned by FPM that is sprayed from below (Step T3), and after executing this cleaning operation for a prescribed time interval of, for example, 90 seconds, the spray of FPM is halted (Steps T3-T5).

Water supply element 203 and ozone-mixing element 210 are next brought into operation at the same time while the low-speed rotation of silicon wafer 50 is continued without change, and the back surface of silicon wafer 50 that is rotating at low speed is cleaned by pure water that is mixed with ozone at a concentration of 8.0 ppm, the rate of flow of the pure water being 2.0 L/min (Step T6).

When this cleaning operation has been executed for a time interval of, for example, 30 seconds (Step T7), the operation of ozone-mixing element 210 is halted while the operation of water supply element 203 is continued without change (Step T8), and the back surface of silicon wafer 50 that is rotating at low speed is cleaned by pure water that is not mixed with ozone.

When this cleaning operation has also been executed for a time interval of, for example, 30 seconds, the spray of pure water by water supply element 203 is halted (Steps T9 and T10), and silicon wafer 50 is then rotated by wafer-securing element 201 at a high speed of approximately 1500 rpm (Step T11). After this high-speed rotation has been executed for a time interval of, for example, 50 seconds (Steps T12 and T13), the dried silicon wafer 50 is finally conveyed out, thus completing the work (Step T14).

The back surface of silicon wafer 50 in which integrated circuits have been formed of copper on its front surface is first cleaned with FPM as described hereinabove, whereby contaminants such as copper that adhere to the back surface of silicon wafer 50 can be effectively removed. Although cleaning the back surface of silicon wafer 50 in this way may produce fluorine compounds, these compounds can be effectively removed by cleaning with pure water that has been mixed with ozone in the back-surface cleaning method that uses back-surface cleaning system 10 of this embodiment.

The back-surface cleaning method that uses back-surface cleaning system 10 of this embodiment is therefore capable of cleaning the back surface of silicon wafer 50, and as a result, when, for example, a plurality of silicon wafers 50 are accommodated in a wafer cassette, the contaminants on the back surface of a particular silicon wafer 50 can be prevented from adhering to the surface of adjacent silicon wafers 50.

Further, because ozone-mixing element 210 mixes ozone into pure water that is supplied by water supply element 203 in back-surface cleaning system 10 of the present embodiment, pure water that is mixed with ozone and pure water that is not mixed with ozone can both be supplied from one water supply element 203, thereby enabling a simplification of the construction of the system and a reduction in the running costs.

Moreover, because ozone-mixing element 210 electrolyzes the pure water that is supplied from water supply element 203 to generate ozone, ozone need not be prepared apart from the pure water, thereby obtaining a further reduction in running costs.

As shown in FIG. 5, actual cleaning of the back surfaces of silicon wafers 50 by different methods that was carried out by the inventors of the present invention confirmed that, in comparison with the back-surface cleaning method of an example of the prior art (labeled “1” in FIG. 5) in which the back surface of silicon wafer 50 that was cleaned with FPM was then cleaned with pure water for 30 seconds, the back-surface cleaning method (“2” and “3” in FIG. 5) using back-surface cleaning system 10 of the present embodiment was able to reduce the compound residue to approximately one-tenth that of the prior art even when the cleaning time in the present embodiment was 15 seconds, or just half that of the prior art, and was able to obtain an even greater reduction in compound residue when the cleaning time was 30 seconds, i.e., of the same duration as the prior art.

The present invention is not limited to the above-described embodiment and allows various modifications within the scope that does not depart from the spirit of the invention. For example, an example was described in the above embodiment in which ozone-mixing element 210 electrolyzed pure water to produce ozone, but ozone may also be provided beforehand in a tank provided exclusively for ozone.

Although an example was described in the above-described embodiment in which ozone-mixing element 210 mixed ozone in pure water that was supplied by water supply element 203, it is also possible to provide pure water that has been mixed with ozone beforehand and then supply this pure water that has been mixed with ozone to silicon wafer 50 separately from pure water that is not mixed with ozone.

Although an example was described in the above embodiment in which solution supply element 202 supplied silicon wafer 50 with FPM that was prepared at an appropriate concentration in advance, it is also possible for solution supply element 202 to mix FPM of a high concentration with pure water and then supply the mixture to silicon wafer 50.

Finally, an example was described in the above embodiment in which each of the means is logically realized as various functions of operation control apparatus 30 through the operation of CPU 301 in accordance with a computer program that is stored in, for example, RAM 304. However, each of these means may be individually formed as hardware with specific characteristics, or a portion may be stored as software in, for example, RAM 304 and a portion may be formed as hardware.

While a preferred embodiment of the present invention has been described using specific terms, such description is for illustrative purposes only, and it is to be understood that changes and variations may be made without departing from the spirit or scope of the following claims.

What is claimed is:

1. A back-surface cleaning method for cleaning the back surface of a disk-shaped silicon wafer having at least a portion of integrated circuits formed of copper on its front surface, said method comprising:
an acidic cleaning step for cleaning the back surface of said silicon wafer with an acidic solution;
an ozone cleaning step for cleaning the back surface of said silicon wafer, which has been cleaned with said acidic solution in said acidic cleaning step, with pure water mixed with ozone;
a pure water cleaning step for cleaning the back surface of said silicon wafer, which has been cleaned with said pure water mixed with said ozone in said ozone cleaning step, with pure water without ozone mixed; and
a back-surface drying step for drying the back surface of said silicon wafer that has been cleaned with said pure water in said pure water cleaning step.

2. A back-surface cleaning system for cleaning the back surface of a disk-shaped silicon wafer having at least a portion of integrated circuits formed of copper on its front surface; said back-surface cleaning system comprising:
acidic cleaning means for cleaning the back surface of said silicon wafer with an acidic solution; ozone cleaning means for cleaning the back surface of said silicon wafer, which has been cleaned with said acidic solution by said acidic cleaning means, with pure water mixed with ozone;
water cleaning means for cleaning the back surface of said silicon wafer, which has been cleaned by said pure water mixed with said ozone by said ozone cleaning means, with pure water without ozone mixed; and
back-surface drying means for drying the back surface of said silicon wafer that has been cleaned with said pure water by said water cleaning means.

3. A back-surface cleaning system for cleaning the back surface of a disk-shaped silicon wafer having at least a portion of integrated circuits formed of copper on its front surface; said back-surface cleaning system comprising:
a wafer-securing element for securing said silicon wafer;
a solution supply element for supplying an acidic solution to the back surface of said silicon wafer that is secured by said wafer-securing element;
a water supply element for supplying pure water to the back surface of said silicon wafer that is secured by said wafer-securing element;
an ozone-mixing element for mixing ozone with pure water that is supplied by said water supply element;
acidic cleaning means for cleaning the back surface of said silicon wafer, which is secured by said wafer-securing element, with said acidic solution of said solution supply element;
ozone cleaning means for cleaning the back surface of said silicon wafer, which has been cleaned by said acidic cleaning means, with said pure water from said water supply element that has been mixed with said ozone by said ozone-mixing element;
water cleaning means for cleaning the back surface of said silicon wafer, which has been cleaned by said ozone cleaning means, with said pure water from said water supply element; and
back-surface drying means for drying the back surface of said silicon wafer that has been cleaned by said water cleaning means.

4. A back-surface cleaning system according to claim 3, wherein said ozone-mixing element electrolyzes said pure water that is supplied from said water supply element to produce said ozone.

5. An operation control method for controlling the operations of a back-surface cleaning system, said system including a wafer-securing element for securing a disk-shaped silicon wafer having at least a portion of integrated circuits formed of copper on its front surface, a solution supply element for supplying an acidic solution to the back surface of said silicon wafer that is secured by said wafer-securing element, a water supply element for supplying pure water to the back surface of said silicon wafer that is secured by said wafer-securing element, an ozone-mixing element for mixing ozone in pure water that is supplied by said water supply element; said operation control method comprising:
a securing control step for securing said silicon wafer in said wafer-securing element; an acidic cleaning step for cleaning the back surface of said silicon wafer, which has been secured in said wafer-securing element in said securing control step, with said acidic solution of said solution supply element;
an ozone cleaning step for cleaning the back surface of said silicon wafer, which has been cleaned in said acidic cleaning step, with said pure water from said water supply element that is mixed with said ozone by said ozone-mixing element;
a pure water cleaning step for cleaning the back surface of said silicon wafer, which has been cleaned in said ozone cleaning step, with said pure water of said pure water supply step; and
a back-surface drying step for drying the back surface of said silicon wafer that has been cleaned in said pure water cleaning step.

6. An operation control apparatus for controlling the operations of a back-surface cleaning system, said system including a wafer-securing element for securing a disk-shaped silicon wafer having at least a portion of integrated circuits formed of copper on its front surface, a solution supply element for supplying an acidic solution to the back surface of said silicon wafer that is secured by said wafer-securing element, a water supply element for supplying pure water to the back surface of said silicon wafer that is secured by said wafer-securing element, an ozone-mixing element for mixing ozone in pure water that is supplied by said water supply element; said operation control apparatus comprising:
securing control means for securing said silicon wafer in said wafer-securing element;
acidic cleaning means for cleaning the back surface of said silicon wafer, which has been secured in said wafer-securing element by said securing control means, with said acidic solution of said solution supply element;
ozone cleaning means for cleaning the back surface of said silicon wafer, which has been cleaned by said acidic cleaning means, with said pure water from said water supply element that has been mixed with said ozone by said ozone-mixing element;
water cleaning means for cleaning the back surface of said silicon wafer, which has been cleaned by said ozone cleaning means, with said pure water from said water supply element; and
back-surface drying means for drying the back surface of said silicon wafer that has been cleaned by said water cleaning means.

7. A computer program for an operation control apparatus for controlling the operations of a back-surface cleaning system, said system including a wafer-securing element for securing a disk-shaped silicon wafer having at least a portion of integrated circuits formed of copper on its front surface, a solution supply element for supplying an acidic solution to the back surface of said silicon wafer that is secured by said wafer-securing element, a water supply element for supplying pure water to the back surface of said silicon wafer that is secured by said wafer-securing element, an ozone-mixing element for mixing ozone in pure water that is supplied by said water supply element; said computer program causing said operation control apparatus to execute:
a securing control process for causing said wafer-securing element to secure said silicon wafer;
an acidic cleaning operation for cleaning the back surface of said silicon wafer, which is secured by said wafer-securing element in said securing control process, with said acidic solution of said solution supply element;
an ozone cleaning operation for cleaning the back surface of said silicon wafer, which has been cleaned by said acidic cleaning operation, with said pure water from said water supply element that has been mixed with said ozone by said ozone-mixing element;
a pure water cleaning operation for cleaning the back surface of said silicon wafer, which has been cleaned by said ozone cleaning operation, with said pure water from said water supply element; and
a back-surface drying process for drying the back surface of said silicon wafer that has been cleaned by said pure water cleaning operation.
